(19) United States
(12) Patent Application Publication
(10) Pub. No.: US 2024/0159573 A1
(43) Pub. Date: May 16, 2024

(54) APPARATUS AND METHOD FOR DETECTING MOVEMENT ALONG AN AXIS

(71) Applicant: AMS SENSORS SINGAPORE PTE. LTD., Singapore (SG)

(72) Inventors: Markus DANTLER, Thalwil (CH); Laurent NEVOU, Wadenswil (CH); Jens GEIGER, Thalwil (CH); Markus ROSSI, Jona (CH); Ferran SUAREZ, Chandler, AZ (US)

(21) Appl. No.: 18/549,593

(22) PCT Filed: Mar. 15, 2022
(86) PCT No.: PCT/SG2022/050133

§ 371 Date: Sep. 8, 2023

Related U.S. Application Data
(60) Provisional application No. 63/162,430, filed on Mar. 17, 2021.

(51) Int. Cl. G01D 5/30; G04C 3/00; G04G 21/00

(52) U.S. Cl. CPC G01D 5/30; G04C 3/001; G04G 21/00

(57) ABSTRACT

An apparatus may provide a control signal based on an axial position of a controller displaceable along an axis. The apparatus may include a component for displacement with said controller along said axis, a radiation source and detector arrangement configured to direct radiation towards a target region and generate a detector signal dependent upon radiation reflected from within that target region, and a computer processor configured to process said detector signal to determine a measure of distance or change of distance to a reflecting surface region within said target region, and to use said measure to provide said control signal. The component may define a reflecting surface that passes through said target region such that a reflecting surface region is present within said target region with a distance that varies with the axial position of the component along said axis.

### CROSS-REFERENCE TO RELATED APPLICATIONS

The present application is a national stage entry according to 35 U.S.C. § 371 of PCT application No.: PCT/SG2022/050133 filed on Mar. 15, 2022; which claims priority to U.S. provisional patent application 63/162,430, filed on Mar. 17, 2021; all of which are incorporated herein by reference in their entirety and for all purposes.

### TECHNICAL FIELD

The present disclosure relates to an apparatus and method for detecting movement of a controller along an axis and in particular, though not necessarily, to such a method and apparatus for use with rotary encoders.

### BACKGROUND

In the field of conventional mechanical watches, the “crown” of the watch is the button or knob that projects from an edge of the watch to allow the user to set the time and date and to control other functions. The crown is fixed to a “stem” or shaft which is the elongate tube that connects the crown to the internal mechanism. For the sake of brevity, the term “crown” as used hereinafter refers to the combination of the conventional crown and stem, unless stated otherwise.

Smartwatches are advanced iterations of the conventional watch and of course include many more features, typically implementing many of the functions of smartphones. However, common to many such smartwatches is the use of a crown-type knob to allow users to access and control functions. The advantage of the crown is that it allows not only control of certain “binary” type operations, e.g. on/off, with a simple button press, it can additionally be used to scroll through many function states by way of rotation. Rotation of the crown can therefore be used to set a time by scrolling through a range of numbers, to scroll through menu option, to zoom a camera feature, etc. FIG. 1 illustrates schematically the main body of a smartwatch 130 comprising a display 131 and a crown 110. Also illustrated are a series of Graphical User Interface (GUI) screens 132 that can be used to control the smartwatch in conjunction with the crown (and possibly other switches and knobs not shown in the drawing).

In order to perform the operations, the smartwatch may include a means for detecting the angular position of the crown about its axis of rotation as well as the position along the axis. This means may detect the absolute position as well as a speed of rotation. This means is commonly referred to as a “rotary encoder” (sometimes called a “shaft encoder”). The measurements that are obtained by a rotary encoder can be converted into an analogue or digital output for further processing. Rotary encoders can include one or more mechanical, optical, magnetic, and/or capacitive components. For example, a rotary encoder can be implemented as an electro-mechanical device. Of course, two factors critical for rotary encoders in the context of smartwatches are miniaturisation and cost.

FIG. 2 illustrates a system for (i) measuring the angular position and/or motion of a rotary shaft 102 coupled to the watch crown 110 via a stem 111, and (ii) detecting a longitudinal movement of the rotary shaft 102. The system 150 includes an optical rotary encoder system 100, a computer system 154, and a display 131 that is controlled by display control signals 156 provided to it by the computer system 154. The system 150 can be used, for example, to control an electronic device such as a smartwatch.

An end view of the rotary shaft 102 is shown in inset A from which it can be seen that a multiplicity of grooves 104 are formed coaxially along the length of the shaft. The rotary encoder 100 includes a system 101 having at least one light generating element 105 operable to generate light, and a pair of light detecting elements 106a, 106b operable to detect light and convert the detected light into a signal. It will be readily apparent that rotation of the control knob 110 results in a corresponding rotation of the rotary shaft 102 causing a modulation of the light 108a, 108b reflected towards the light detecting elements. Electrical signals 155 generated by the light detecting elements 106a, 106b are provided to the computer system 154, allowing the computer system to demodulate the signals and thereby detect a rotation and position of the rotary shaft 102 about its axis 111a.

The system 150 includes a switching contact mechanism 152 (e.g., a push button mechanism) positioned proximate to the end of rotary shaft 102. Further, the system includes a spring element 151 that biases the rotary shaft 102 away from a switching contract mechanism 152. When a user is not pressing the control knob 110, the rotary shaft 102 is positioned away from the switching contact mechanism 152, and the switching contact mechanism 152 remains electrically open. When the user presses the control knob/crown 110 inward (e.g., in the direction of arrow 158), the rotary shaft 102 presses against the switch contact mechanism 152, and causes the switching contact mechanism 152 to electrically close. The computer system 154 can detect the opening and closing of the switch contact mechanism 152 by monitoring (e.g., via wires or a flexible printed circuit board) control signal 153, and control the operation of the electronic device 130 accordingly.

WO2019156629A1 describes an improvement upon the rotary encoder of FIG. 1 and which involves replacing the switching contact mechanism 152 by introducing a further marking around the rotary shaft 102 at a given axial position. This lies outside of the illuminated region of the shaft when the control knob 110 is in its resting position. However, when the knob is depressed, the further marking moves into this illuminated region and produces a modulation of the reflected light that is detectable by the light detecting elements 106a, 106b and the coupled computer system 154. The marking may be, for example, a dark band that contrasts with a reflective metallic surface of the rest of the rotary shaft. The rotary encoder of WO2019156629A1 reduces the overall component count and therefore offers the possibility of reduced cost.

US20190317454A1 also describes a rotary encoder suitable for a smart watch. The approach relies upon the coherent mixing of light reflected from the watch's rotary shaft with the source light to detect rotation of the shaft.

### SUMMARY

Embodiments may allow detection of movement of the controller along the axis regardless or angular orientation of the controller, thereby allowing the apparatus to additionally comprise a rotary encoder.

### BRIEF DESCRIPTION OF THE DRAWINGS

FIG. 1 illustrates schematically a known smartwatch design;

FIG. 2 illustrates a known rotary encoder with axial position detection mechanism;

FIGS. 3a-c illustrate a first embodiment for detection an axial position of a controller;

FIGS. 4a-c illustrate a second embodiment for detection an axial position of a controller;

FIGS. 5a-d illustrate a third embodiment for detection an axial position of a controller;

FIG. 6 illustrates an axial position versus distance profile for the embodiment of FIG. 5;

FIGS. 7a-c illustrate a fourth embodiment for detection an axial position of a controller;

FIGS. 8a-d illustrate various light source and detector arrangements for measuring a distance; and

FIGS. 9a-b illustrate the incorporation of lenses into a light source and detector arrangement.

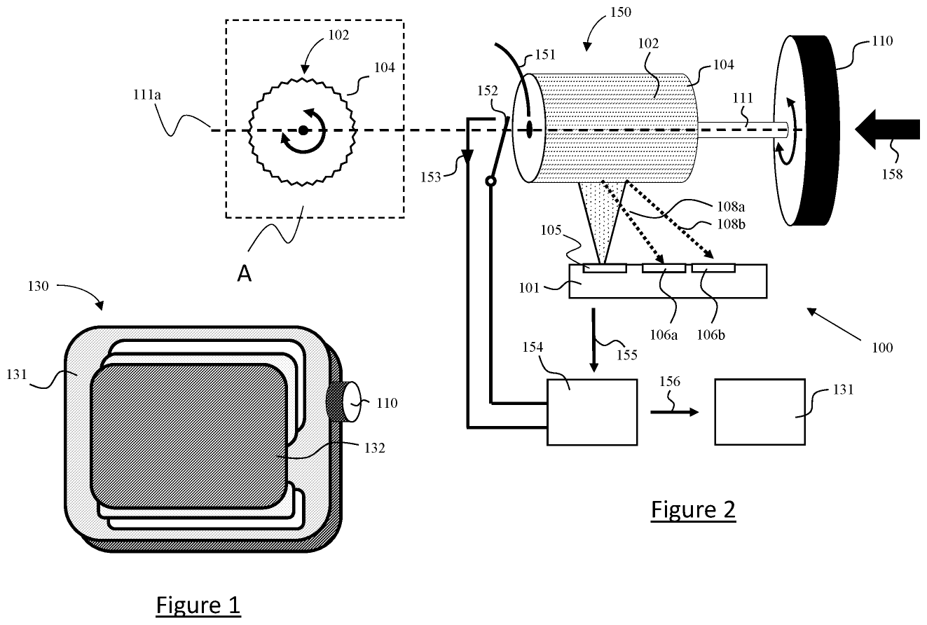

### DETAILED DESCRIPTION

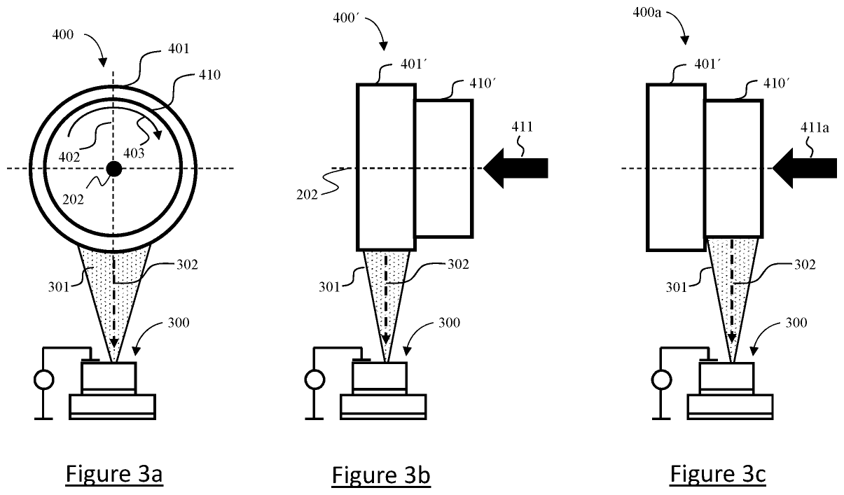

As has already been discussed above, it is desirable or even necessary to be able to detect movement of the knob or crown 110 along an axis of rotation 202 as well as potentially around that axis. A conventional electromechanical arrangement was described with reference to FIG. 2. It is also known to use visible markings on the rotary shaft 102 that can be detected by optical means to indicate such an axial movement. Such visible markings can be provided around the eccentric components described with respect to FIGS. 3 to 12 such that they are detected by the light source and detector arrangement 300 upon axial movement of the eccentric components. FIGS. 13a-c illustrate an alternative arrangement that relies on detecting changes in distance, where FIG. 3a illustrates an end-on view of the arrangement, looking into the device (e.g. the smartwatch), whilst FIGS. 3b and 3c illustrate side views of the arrangement.

In this arrangement, a component 400, which in this example is a circular cylinder, is provided with a step change in its diameter at a given axial position. This gives rise to two distinct sections, 40T and 410′, with the former having a greater diameter than the latter. The larger section 40T lies within the illuminated region of the light source and detector arrangement 300 in the resting axial position of the knob 110, i.e. when the knob is not being pressed. When the knob is pressed in, e.g. against the resistance provided by an internal spring, the smaller section 410′ moves into the illuminated region as illustrated by the change between FIGS. 13b and 13c. The resulting (step) change in distance between the light source and detector arrangement 300 and the surface of the eccentric component can be detected and taken as indicative of a button press. A press can be detected regardless of the rotational orientation of the component 400. It will be further appreciated that multiple step changes can be provided along the length of the eccentric component to allow different extents of button press to be detected. Such step changes may also be used to detect pulling of the knob into an extended state.

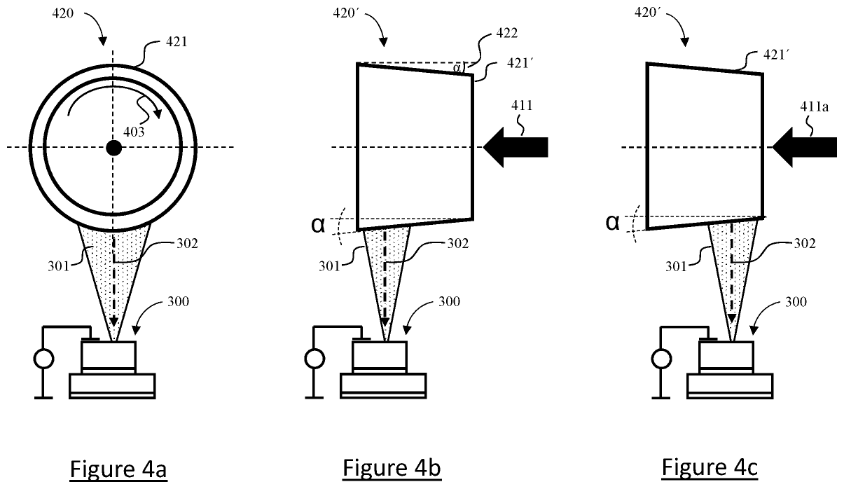

FIGS. 4a-c illustrate an alternative arrangement in which the diameter varies linearly (at an angle a to the axis of rotation) along the axis of the eccentric component 420. With this arrangement, it is possible not only to determine that a particular axial position has been crossed (indicated by the step), but one can quantitatively determine an axial position. This arrangement potentially provides an additional “degree of freedom” for controlling the device.

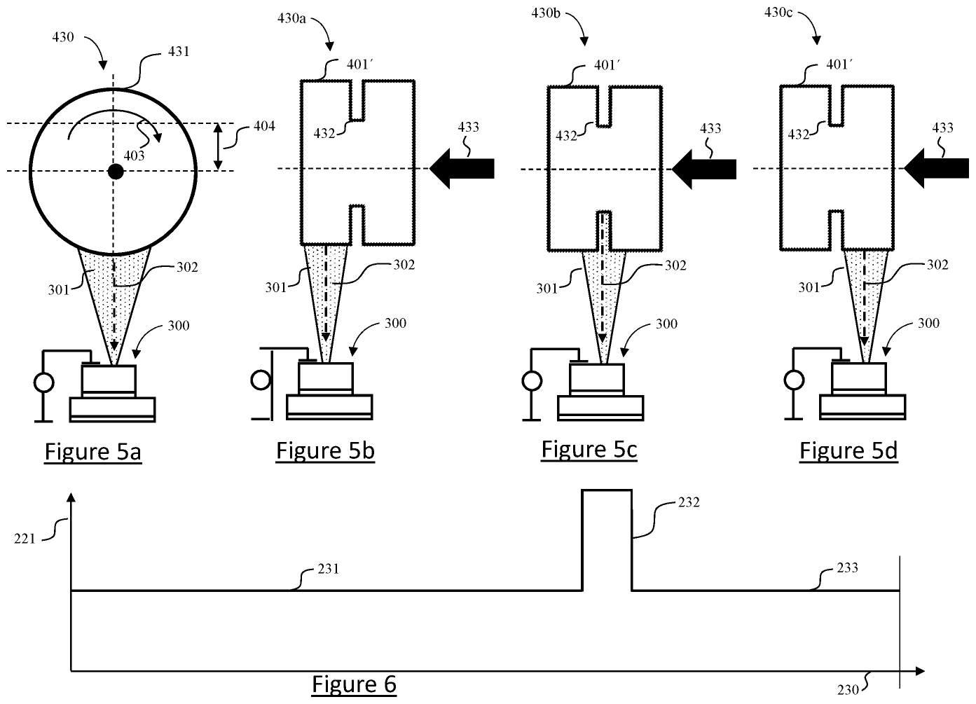

FIGS. 5a-d illustrate a yet further alternative arrangement in which the component 430 is provided with a circumferentially extending notch 432 at an intermediate axial location. The notch lies outside of the normal region of illumination, but moves across that region when the knob 110 is pressed. A complete pressing of the knob moves an axial section of the component on the other side of the notch into the illumination region. A button press is therefore detected by observing a short increase in the measured distance. Similarly the release of the knob is detected by a subsequent, temporary change in the distance. Operation of the arrangement is further illustrated by the distance versus axial position profile of FIG. 6.

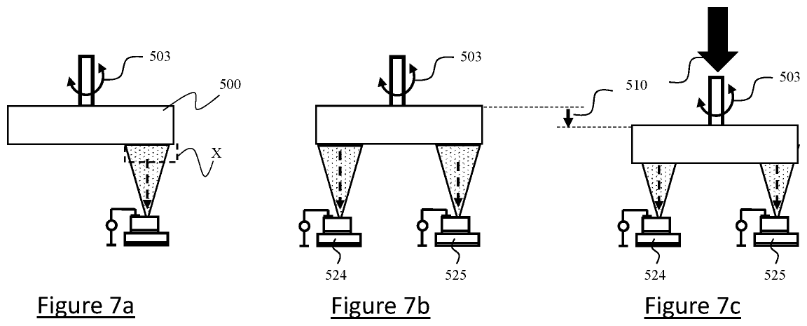

The arrangements described above rely on measuring a distance to a circumferential edge of a component mounted with respect to a rotation axis. FIGS. 7a-c illustrate an arrangement that employs an alternative approach. In this arrangement the light source and detector arrangement are located at a position that is axially spaced from the (innermost) end of the component 500. The light source and detector arrangement directs a beam of light in a substantially coaxial direction so that it is incident on and is reflected from the end of the component.

FIG. 7a illustrates a light source and detector arrangement which uses a single arrangement providing a single distance measurement. FIG. 7b illustrates an alternative light source and detector arrangement which utilises a pair of such arrangements providing a pair of distance measurements, with the target region for the light beam indicated by “X”. The use of a pair of light source and detector arrangements provides for redundancy and therefore increased reliability and security.

The mechanisms described above are well suited to use in smartwatches where miniaturisation of the encoders is desired. The measure of distance derived, be that a direct measure or an indirect measure, can be used as or to derive a control signal for the smartwatch. The described mechanisms can find application in other areas of course, including but not limited to conventional electromechanical watches and smartphones.

Considering now light source and detector arrangements suitable for use with the embodiments described above, these may rely on SMI (self-mixing interference). This is a well-known technique in which light is emitted from a resonant light source (having an optical resonator in which the light circulates), e.g., a laser, with reflected (or scattered) light being fed-back into the resonator. The feed-back light interacts with the light in the resonator or, more precisely, it introduces a disturbance in the light source by interference. This effect can be sensed and can be related to the interaction with the object, such as to a distance to the object or a velocity of the object (relative to the light source/resonator exit mirror). By calibration, it is possible to map an output signal of the SMI arrangement to a distance. SMI-based sensors can be made very compact and therefore small, and make possible absolute distance and velocity measurements. VCSELs (vertical-cavity surface emitting lasers) can be used for SMI, which can be made very small and cost-efficient.

Considering this approach in more detail, the intensity of light output by the VCSEL various sinusoidally as the distance between the resonator and the target changes. Consequently, the output of the detector will also vary sinusoidally. A measure of change of distance can be obtained by counting the number of fringes (peaks and troughs) in the output signal.

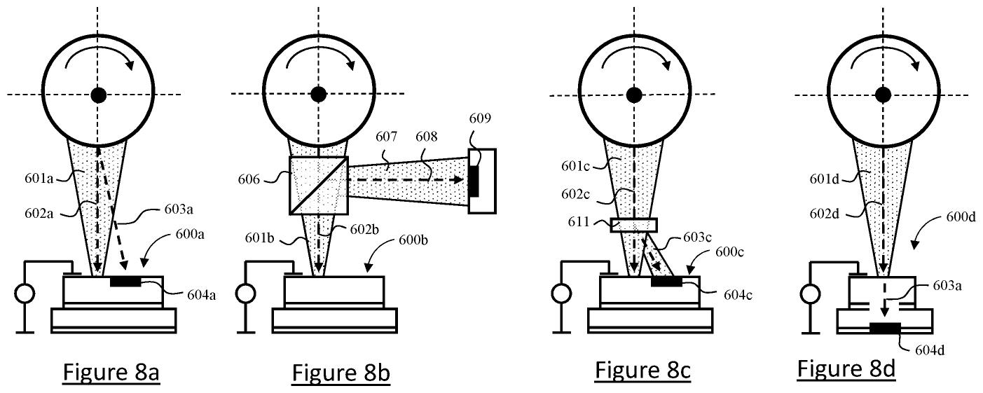

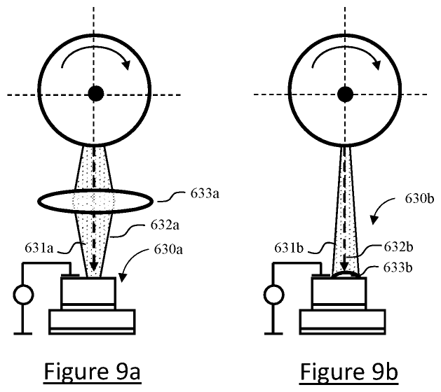

Various means to determine the distance to the reflecting/scattering surface are illustrated in FIGS. 8a to 8d:

FIG. 8a. Light emitted by the VCSEL, by way of reflection from the target, is detected using a photodiode 604a. The intensity of the emitted light, indicated by the output current of the photodiode, can be correlated with distance.

FIG. 8b. A beam splitter 606 can be positioned close to the exit mirror to pass most of the light exiting the exit mirror and reflect a small portion thereof to a photodetector 609. Again, detected light intensity can be correlated with distance.

FIG. 8c. A cover glass 611 is located between the light source and the target so that a portion of the emitted light is reflected back from the cover glass to the detector 604c. FIG. 8d. A photodetector 604d is located directly beneath the VCSEL to detect light generated within the resonator.

Alternative arrangements for detecting a measure of distance may involve monitoring a drive signal for the light source, e.g.,
1) the light source is driven with constant current, and a change in voltage is determined; or
2) the light source is driven with a constant voltage, and a change in current is determined.

The electrical signal may however be noisier than an optically obtained signal (FIGS. 8a-d).

It will be appreciated by the person of skill in the art that various modifications may be made to the above described embodiments without departing from the scope of the present invention. These may include, by way of example:
Operating the laser at any wavelength from UV to IR;
Using an edge emitter laser EEL, VCSEL, quantum dot laser QDL or quantum cascade laser QCL;
In case of a VCSEL, the VCSEL can be front side or back side emitting VCSEL;
In case of VCSEL, a lens 633a can be added in order to focus the beam or collimate the beam on the disc or shaft as illustrated in FIG. 9a, or a lens 633b can integrated onto the VCSEL itself using a back side emitting VCSEL, FIG. 9b.

It will be further appreciated that the light source (and detector) may be replaced by any other suitable radiation source and detector, for example operating in the visible of non-visible spectra, e.g. infra-red, ultra-violet.

1. An apparatus for providing a control signal based on an axial position of a controller displaceable along an axis, the apparatus comprising:
a component for displacement with said controller along said axis;
a radiation source and detector arrangement configured to direct radiation towards a target region and generate a detector signal dependent upon radiation reflected from within that target region;
a computer processor configured to process said detector signal to determine a measure of distance or change of distance to a reflecting surface region within said target region, and to use said measure to provide said control signal,
wherein said component defines a reflecting surface that passes through said target region such that a reflecting surface region is present within said target region with a distance that varies with the axial position of the component along said axis.

2. The apparatus according to claim 1, wherein said radiation source and detector arrangement is configured to direct radiation towards said target region in a direction substantially perpendicularly with respect to said axis, and said reflecting surface of the component extends around a circumferential region of the component.

3. The apparatus according to claim 2, wherein said component is substantially in the form of a circular or elliptical cylinder.

4. The apparatus according to claim 1, wherein said radiation source and detector arrangement is configured to direct radiation towards said target region in a direction substantially parallel to said axis, and said reflecting surface is provided by a substantially transverse end region of the component.

5. The apparatus according to claim 1, wherein said component defines one of: a groove or ridge extending substantially circumferentially around the component; a step change in the cross-sectional shape of the component along the axis; or a tapering of the cross-sectional shape of the component along the axis.

6. The apparatus according to claim 1, further comprising a spring mechanism for providing a restoring force along said axis to resist a pressing of the controller.

7. The apparatus according to claim 1, wherein said radiation source and detector arrangement comprises a radiation source and a radiation detector.

8. The apparatus according to claim 7, wherein said radiation source and said radiation detector are substantially co-located.

9. The apparatus according to claim 7, wherein said radiation source and said radiation detector are provided at spaced apart locations, and the apparatus comprises a means for diverting radiation to the radiation detector.

10. The apparatus according to claim 1, wherein said distance is a distance from said radiation source to said reflecting surface region.

11. The apparatus according to claim 10, wherein said radiation source is a VCSEL.

12. The apparatus according to claim 11, wherein said radiation detector is a photodiode.

13. The apparatus according to claim 1, wherein said radiation source and detector arrangement is a source and detector arrangement for one or more of visible light, infra red radiation, and ultra-violet radiation.

14. The apparatus according to claim 1, further comprising a rotary encoder for determining an angular position, or change of angular position, of said component about said axis.

15. A watch comprising the apparatus according to claim 1, said controller being a crown of the watch.

16. The watch according to claim 15, the watch being a smart watch and said computer processor being configured to use a determined measure of distance or change of distance to control one or more functions of the smartwatch.

17. A method for providing a control signal based on an axial position of a controller displaceable along an axis, the method comprising:
causing a component coupled to said controller to be displaced with said controller along said axis;
directing a beam of radiation towards a target region and generating a detector signal dependent upon radiation reflected from within that target region;
using said detector signal to determine a measure of distance or change of distance to a reflecting surface region within said target region, wherein said component defines a reflecting surface that passes through said target region such that a reflecting surface region is present within said target region with a distance that varies with the axial position of the component along said axis; and
using said measure to provide said control signal.

18. The method according to claim 17, wherein said distance is a distance from a radiation source or a radiation detector of the radiation source and radiation detector arrangement.

19. The method according to claim 18, wherein said radiation source is a VCSEL and said radiation detector is a photodiode.
